(19) United States
(12) Patent Application Publication
(10) Pub. No.: US 2026/0367690 A1
(43) Pub. Date: Nov. 19, 2026

(54) STORAGE APPARATUS AND CONTROL METHOD OF SAME

(71) Applicant: Hitachi Vantara, Ltd., Kanagawa-ken (JP)

(72) Inventors: Shugo OGAWA, Tokyo (JP); Yoshihiro YOSHII, Tokyo (JP)

(21) Appl. No.: 19/544,850

(22) Filed: Feb. 19, 2026

(30) Foreign Application Priority Data
May 16, 2025 (JP) 2025-082920

(51) Int. Cl. G06F 1/324; G06F 1/3203; G06F 1/3234

(52) U.S. Cl. CPC G06F 1/324; G06F 1/3203; G06F 1/3234

(57) ABSTRACT

The maximum value of the usage rate of the processor that can satisfy the performance requirement for the storage apparatus is defined as the upper usage rate limit, the number of cores in the operating state that maximizes the effect of reducing the power consumption of the processor while satisfying the performance requirement is calculated as the target core number based on the ratio of the actual usage rate of the processor to the upper usage rate limit, and the process of stopping the operation of the core or resuming the core in the stopped state to the operating state is periodically executed such that the calculated target core number is equal to the number of cores in the operating state.

### CROSS REFERENCE TO RELATED APPLICATION

This application relates to and claims the benefit of priority from Japanese Patent Application No. 2025-082920, filed on May 16, 2025 the entire disclosure of which is incorporated herein by reference.

### BACKGROUND OF THE INVENTION

### 1. Field of the Invention

The present invention relates to a storage apparatus and a control method thereof, and is suitable for application to, for example, a storage system.

### 2. Description of the Related Art

Improvement in performance of computer hardware is essential to cope with an increase in the amount of data due to development of a computer system and an increase in processing load due to complication of an application. On the other hand, hardware including a central processing unit (CPU) constituting a computer has higher power consumption as performance is improved. Therefore, it is required to reduce the power consumption of the computer system from the viewpoint of operating cost of the computer system and consideration of the environment.

The CPU is one of hardware components that affect the processing capability of the computer and has high power consumption.

As one means for reducing the power consumption of the CPU, a method of controlling the operation frequency according to the load of the CPU is known. This method uses the fact that the performance and the power consumption of the CPU are proportional to the operation frequency, and reduces the power consumption while maintaining the required performance by increasing or decreasing the operation frequency according to the usage rate of the CPU and reducing the operation frequency when the CPU has a low load.

### SUMMARY OF THE INVENTION

In a storage system that receives a request from an external host and reads/writes and stores data, a CPU of a controller that executes a process according to an access request from the host affects access performance from the host, and thus high performance is required.

On the other hand, a high-performance CPU consumes a large amount of power, and the CPU of the controller is one of hardware components consuming a large power consumption also in the storage system. Therefore, when reducing the power consumption of the storage system, it is essential to reduce the power consumption of the CPU.

Since the reduction of the power consumption of the CPU is realized by the suppression of the processing performance, in order to satisfy both the request for the access performance of the storage system and the request for the reduction of the power consumption, it is necessary to determine the processing capability of the CPU necessary for realizing the access performance required for the storage system and to reduce the power consumption of the CPU so as to suppress the excessive processing performance.

As a means for reducing the power consumption by suppressing the performance of the CPU, a method of controlling the operation frequency according to the processing load is used. However, in a case where the operation frequency is controlled for the CPU of the controller of the storage system, the command execution speed of the program that processes the access request decreases, and thus, the response time to the access request increases. Therefore, when it is necessary to maintain constant response performance to an access request, the response time increases due to a decrease in the operation frequency of the CPU, so that the operation frequency cannot be sufficiently decreased, and the reduction amount of the power consumption becomes small.

For example, U.S. Pat. No. 12,204,775 discloses a method of monitoring a processing load for each part of a storage system such as a CPU of a controller, shifting to a mode with low power consumption for each part within a range not affecting I/O performance, or cutting off a power supply of a part of hardware as a technology for achieving both reduction in power consumption and performance maintenance of the storage system.

However, in U.S. Pat. No. 12,204,775, a response time is not included in a requirement of input/output (I/O) performance, and reduction of power consumption in consideration of the I/O performance including the response time is not disclosed.

The present invention has been made in view of the above points, and an object of the present invention is to propose a storage apparatus and a control method thereof that can reduce power consumption while satisfying performance requirements.

In order to solve such a problem, in the present invention, there is provided a storage apparatus that provides a storage area for reading and writing data from and to a host apparatus, the storage apparatus including a storage device that provides the storage area for reading and writing data from and to the host apparatus, and a controller that reads and writes data from and to the storage area of the storage device in response to a request from the host apparatus. The controller includes a processor. The processor includes a plurality of cores that read and write data from and to the storage area of the storage device in response to a request from the host apparatus. A maximum value of a usage rate of the processor capable of satisfying a performance requirement for the storage apparatus is defined as an upper usage rate limit. A number of cores in an operating state that maximizes an effect of reducing power consumption of the processor while satisfying the performance requirement is calculated as a target core number based on a ratio of an actual usage rate of the processor to the upper usage rate limit, and an operation of the core is stopped or the core in a stopped state is resumed to an operating state such that the number of cores in the operating state is equal to the calculated target core number.

Furthermore, according to the present invention, there is provided a control method of a storage apparatus that provides a storage area for reading and writing data from and to a host apparatus. The storage apparatus includes a storage device that provides the storage area for reading and writing data from and to the host apparatus, and a controller that reads and writes data from and to the storage area of the storage device in response to a request from the host apparatus. In the controller, a processor is provided which includes a plurality of cores that read and write data from and to the storage area of the storage device in response to a request from the host apparatus. A maximum value of a usage rate of the processor capable of satisfying a performance requirement for the storage apparatus is defined as an upper usage rate limit. The control method includes a first step of calculating, by the storage apparatus, a number of cores in an operating state that maximizes an effect of reducing power consumption of the processor while satisfying the performance requirement as a target core number based on a ratio of an actual usage rate of the processor to the upper usage rate limit, and a second step of stopping, by the storage apparatus, an operation of the core or resuming the core in a stopped state to an operating state such that the number of cores in the operating state is equal to the calculated target core number.

According to the storage apparatus and the control method thereof the present invention, the number of cores in the operating state of the processor is controlled so as to be equal to the target core number at all times.

According to the present invention, it is possible to realize a storage apparatus and a control method thereof capable of reducing power consumption while satisfying requirements regarding performance.

### BRIEF DESCRIPTION OF THE DRAWINGS

FIG. 1 is a block diagram illustrating a schematic configuration of a storage system according to first and second embodiments;

FIG. 2 is a block diagram illustrating a schematic configuration of a controller according to the first embodiment;

FIG. 3 is a block diagram illustrating a configuration of a CPU;

FIG. 4 is a block diagram illustrating a logical configuration of a memory according to the first embodiment;

FIG. 5 is a block diagram illustrating a logical configuration of a core stop processing metadata area according to the first embodiment;

FIG. 6 is a flowchart illustrating a processing procedure of core stop/resume control processing;

FIG. 7 is a block diagram illustrating a schematic configuration of a controller according to a second embodiment;

FIG. 8 is a block diagram illustrating a logical configuration of a memory according to the second embodiment;

FIG. 9 is a block diagram illustrating a logical configuration of a core stop processing metadata area according to the second embodiment; and

FIG. 10 is a flowchart illustrating a processing procedure of upper usage rate limit update processing.

### DESCRIPTION OF THE PREFERRED EMBODIMENTS

Hereinafter, an embodiment of the present invention will be described in detail with reference to the drawings.

### (1) First Embodiment

In the present embodiment, an example will be described in which the controller of the storage apparatus reduces the power consumption of the CPU while satisfying the requirement related to the performance including the response time with respect to the storage apparatus by stopping or restarting the core of the CPU according to the load of the CPU.

### (1-1) Configuration of Storage System According to Present Embodiment

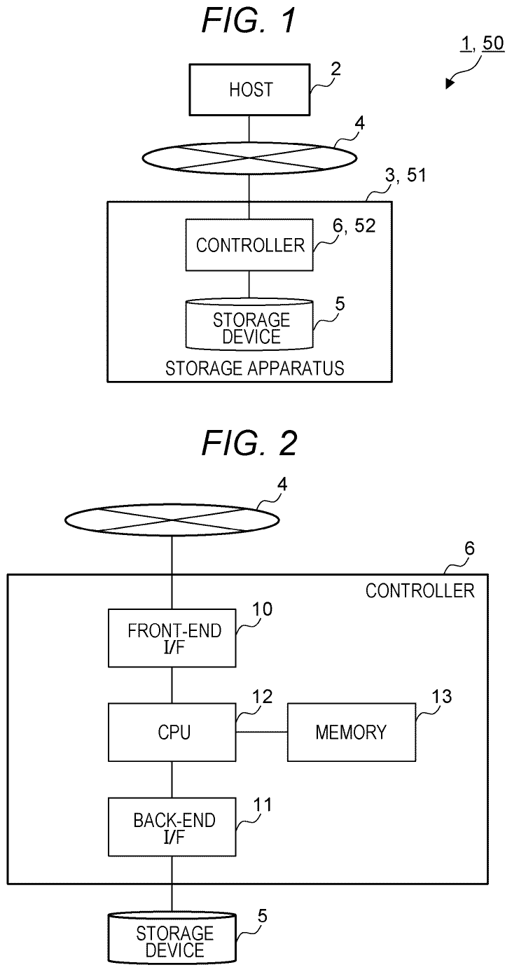

In FIG. 1, 1 indicates a storage system as a whole. The storage system 1 includes one or more hosts 2 and a storage apparatus 3.

The host 2 includes, for example, a general-purpose computer apparatus, and is connected to the storage apparatus 3 via a front-end network 4. The host 2 transmits an access request to the storage apparatus 3 via the front-end network 4 in response to a user's operation or in response to a request from an implemented program.

The storage apparatus 3 includes one or more storage devices 5 and a controller 6.

The storage device 5 includes one or more large-capacity nonvolatile storage media that provide a storage area for reading and writing data from and to the host 2. As such a storage medium, a large-capacity and nonvolatile storage medium such as a solid state drive (SSD) connected by a serial attached small computer system interface (serial attached SCSI; SAS), a non-volatile memory express (NVMe), a serial advanced technology attachment (Serial ATA; SATA), or the like is applied. The storage device 5 may include a redundant array of inexpensive disks (RAID) in which these storage media are combined.

The controller 6 is a functional unit that reads and writes data from and to the storage device 5 in response to an access request from the host 2. The controller 6 receives and interprets an access request transmitted from the host 2 via the front-end network 4. Then, based on the interpretation result of the access request, the controller 6 reads data from the corresponding storage area of the storage device 5 or writes data in the storage area, and responds to the host 2 with the result.

In FIG. 1, the storage device 5 of the storage apparatus 3 and the controller 6 may be connected via the front-end network 4.

FIG. 2 illustrates a configuration example of the controller 6 according to the present exemplary embodiment. The controller 6 includes a front-end interface 10, a back-end interface 11, a CPU 12, and a memory 13.

The front-end interface 10 is an interface for communicating with the host 2 via the front-end network 4, and transmits and receives data related to an access request from the host 2, for example.

The back-end interface 11 is an interface used when the controller 6 communicates with the storage device 5, notifies the storage device 5 of an access request from the controller 6, and transmits and receives data to be read and written from and to the storage device 5.

The CPU 12 is a processor that controls the operation of the entire controller 6, and processes an access request from the host 2 to the storage device 5 based on a program stored in the memory 13. Various programs executed by the CPU 12 are stored in the memory 13. The RAM area is used as a working memory for temporarily storing data.

Note that communication standards and protocols in the front-end interface 10 and the back-end interface 11 are not particularly limited as long as the interfaces can operate as interfaces. Furthermore, FIG. 2 illustrates a case where the front-end interface 10 and the back-end interface 11 are configured separately. However, in a case where the connection between the controller 6 and the storage device 5 is included in the front-end network 4, the controller 6 may have only the front-end interface 10 without providing the back-end interface 11.

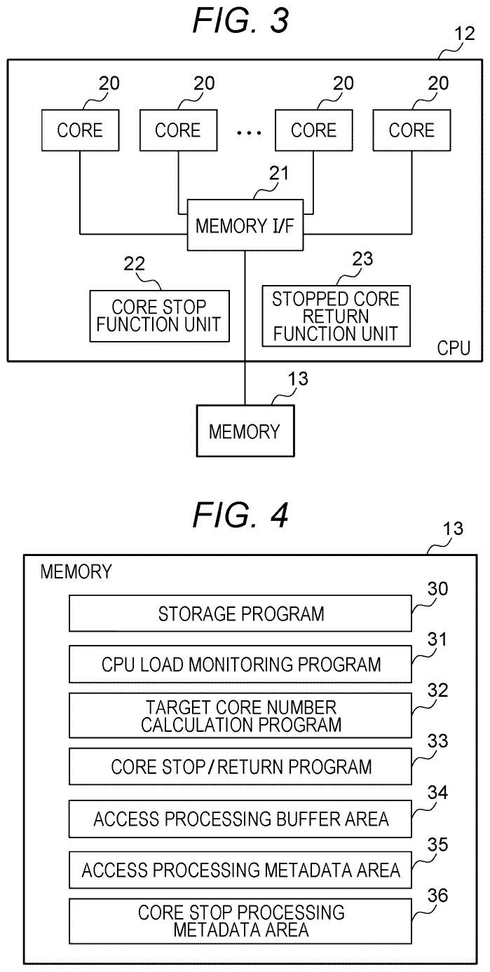

FIG. 3 illustrates a configuration example of the CPU 12 described above. The CPU 12 includes one or more cores 20, a memory interface 21, a core stop function unit 22, and a stopped core resume function unit 23.

Each core 20 interprets an access request from the host 2, reads a program for executing access processing according to the request from the memory 13 via the memory interface 21, and executes the program. The memory interface 21 is an interface that provides the core 20 with a function of accessing the memory 13.

The core stop function unit 22 is a functional unit that stops the operation of the core 20 designated by a core stop/resume program 33 (FIG. 4) to be described later and switches to a state in which power is not consumed. The stopped core resume function unit 23 is a functional unit having a function of recovering the state of the core 20 designated by the core stop/resume program 33 from the stopped state to the operating state in which the program can be executed. The configurations of the core stop function unit 22 and the stopped core resume function unit 23 may be either a software configuration or a hardware configuration.

FIG. 4 illustrates a logical configuration of the memory 13 of the controller 6. As illustrated in FIG. 4, the memory 13 stores a storage program 30, a CPU load monitoring program 31, a target core number calculation program 32, and a core stop/resume program 33, and is provided with an access processing buffer area 34, an access processing metadata area 35, and a core stop processing metadata area 36.

The storage program 30 is a program having a function of performing access processing in response to an access request from the host 2. Each core 20 constituting the CPU 12 executes necessary access processing such as read processing and write processing based on the storage program 30.

The CPU load monitoring program 31 is a program having a function of monitoring a command execution status of each core 20 and calculating a usage rate (hereinafter, referred to as a CPU usage rate) of the CPU 12 for each CPU 12 by an existing method. The core 20 of the CPU 12 calculates the CPU usage rate based on the CPU load monitoring program 31.

The target core number calculation program 32 is a program having a function of calculating the number (hereinafter, referred to as a target core number) of the cores 20 to be set in the operating state at that time based on the CPU usage rate calculated by the CPU load monitoring program 31. Based on the target core number calculation program 32, the core 20 of the CPU 12 periodically calculates the target core number that maximizes the reduction amount of the power consumption while satisfying the performance required for the storage apparatus 3 with respect to the current load.

The core stop/resume program 33 is a program having a function of comparing the target core number calculated by the target core number calculation program 32 with the number of cores 20 in the operating state at that time, instructing the core stop function unit 22 to stop the operation of the cores 20 by the number that is the difference between both when the number of cores 20 in the operating state exceeds the target core number, and instructing the stopped core resume function unit to resume the number of cores 20 in the stopped state that is the difference between both to the operating state when the number of cores 20 in the operating state falls below the target core number. The core 20 of the CPU 12 controls the core stop function unit 22 and the stopped core resume function unit 23 such that the number of cores 20 in the operating state is equal to the target core number based on the core stop/resume program 33.

On the other hand, the access processing buffer area 34 is a buffer area in which data to be read from or written to the storage device 5 (FIG. 1) at the time of executing the access processing is temporarily stored. In the access processing metadata area 35, metadata used for management and control of an access request from the host 2 in the access processing executed based on the storage program 30 is stored.

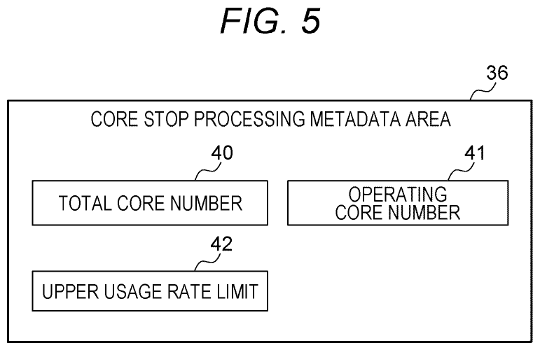

Further, in the core stop processing metadata area 36, metadata used to stop the remaining cores 20 while operating the number of cores 20 according to the CPU usage rate is stored. As illustrated in FIG. 5, such metadata includes data of a total core number 40, an operating core number 41, and an upper usage rate limit 42.

The total core number 40 is the total number of cores 20 constituting the CPU 12 mounted on the controller 6, and is stored in the core stop processing metadata area 36 in advance. The operating core number 41 is the total number of cores 20 (that is, cores 20 in an operating state) that are not in a stopped state and can process an access request from the host 2, and is updated as needed by, for example, the core stop/resume program 33. The number of operating cores may be, for example, in the form of a flag that is provided corresponding to each core 20 of the CPU 12 and indicates whether the corresponding core 20 is in the operating state, in addition to the numerical value indicating the total number of the cores 20 in the operating state.

The upper usage rate limit 42 represents the maximum value of the usage rate that can satisfy the requirements regarding the response time of the storage apparatus 3 and other performances when all the cores 20 constituting the CPU 12 are in the operating state. A predefined value of the upper usage rate limit 42 is stored in the core stop processing metadata area 36. When the CPU usage rate exceeds the upper usage rate limit, the load of processing for the access request from the host 2 becomes excessive, and it becomes difficult to satisfy the requirement regarding the performance of the storage apparatus 3.

### (1-2) Core Stop/Resume Control Processing

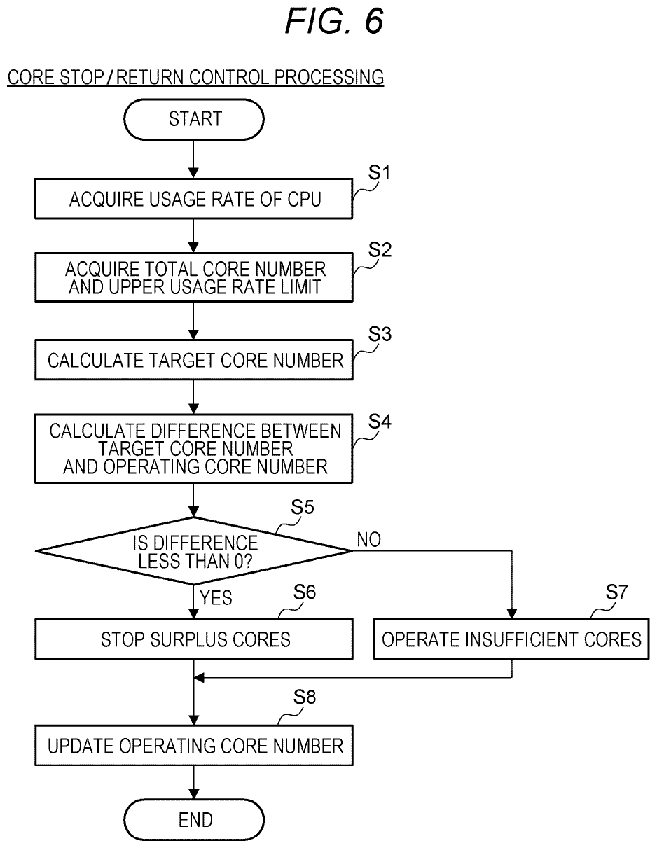

FIG. 6 illustrates a flow of a series of processes (hereinafter, referred to as core stop/resume control processing) periodically executed in the controller 6 of the storage apparatus 3 in relation to the above-described function of stopping the core 20 or resuming the core 20 in the stopped state to the operating state according to the load of the CPU 12.

In the following description, the processing subject of each processing will be described as a “program”, but in practice, it goes without saying that the core 20 having the lowest load at that time of the CPU 12 or a predetermined specific core 20 executes the processing based on the program.

When the power supply of the storage apparatus 3 is turned on and the controller 6 starts the operation, the core stop/resume control processing is started, and first, the target core number calculation program 32 (FIG. 4) acquires the usage rate (CPU usage rate) of the CPU 12 in the controller 6 at that time (S1). Specifically, the target core number calculation program 32 activates the CPU load monitoring program 31 (FIG. 4) to calculate the CPU usage rate at that time, and acquires the calculated CPU usage rate from the CPU load monitoring program 31.

However, when the CPU load monitoring program 31 is activated at all times and the CPU usage rate is calculated as appropriate, the target core number calculation program 32 may acquire the CPU usage rate finally calculated by the CPU load monitoring program 31.

Subsequently, the target core number calculation program 32 reads and acquires each data of the total core number 40 (FIG. 5) and the upper usage rate limit 42 (FIG. 5) stored in the core stop processing metadata area 36 (FIG. 4) of the memory 13 (S2).

Next, the target core number calculation program 32 calculates the target core number based on the CPU usage rate acquired in step S1 and the total core number 40 and the upper usage rate limit 42 acquired in step S2 (S3) as in the following expression.

$$[ Math . 1 ]$$

$$Target core number = \frac{\text{?} + \text{?} core number}{upper usage rate limit} \qquad ( 1 )$$

$$\text{?} \text{indicates text missing or illegible when filed}$$

Here, the target core number can be calculated by multiplying the ratio of the actual CPU usage rate to the upper usage rate limit by the total core number.

At this time, the target core number calculation program 32 sets a value obtained by rounding up decimal places as the target core number when the calculated target core number is a non-integer value, and sets the target core number as a value of the total core number 40 when the calculated target core number exceeds the total core number 40.

Subsequently, the core stop/resume program 33 receives the target core number calculated by the target core number calculation program 32 in step S3. In addition, the core stop/resume program 33 reads the operating core number 41 (FIG. 5) from the core stop processing metadata area 36 of the memory 13. Then, the core stop/resume program 33 calculates a difference between the target core number and the operating core number 41 by subtracting the operating core number 41 from the target core number (S4), and determines whether the calculated difference is less than “0” (S5).

Obtaining an affirmative result in this determination means that the operating core number 41 is larger than the target core number, and the cores 20 that are surplus with respect to the requirement regarding the performance of the storage apparatus 3 are in the operating state. Therefore, in this case, the core stop/resume program 33 selects the number of cores 20 corresponding to the absolute value of the value calculated in step S4 from among the cores 20 in the operating state at that time, and gives an instruction to the core stop function unit 22 (FIG. 3) to stop the operation of each selected core 20 (S6). As a result, the operation of each of the selected cores 20 is stopped by the core stop function unit 22.

On the other hand, obtaining a negative result in the determination in step S5 means that the operating core number 41 is insufficient with respect to the target core number, and there is a possibility that the requirement regarding the performance of the storage apparatus 3 cannot be satisfied. Therefore, in this case, the core stop/resume program 33 selects the number of cores calculated in step S4 from among the cores 20 in the stopped state, and gives an instruction to the stopped core resume function unit 23 (FIG. 3) to resume the selected cores 20 to the operating state (S7). As a result, each of the selected cores 20 is resumed to the operating state by the stopped core resume function unit 23. When the difference calculated in the determination in step S5 is exactly “0”, that is, when the target core number and the operating core number are the same, either the process of giving an instruction of “restarting 0 cores” to the stopped core resume function unit 23 (FIG. 3) or the process of giving an instruction to the stopped core resume function unit 23 (FIG. 3) is skipped.

Next, the core stop/resume program 33 updates the operating core number 41 stored in the core stop processing metadata area 36 of the memory 13 to the target core number calculated in step S3 (S8), and then ends the core stop/resume control processing.

(1-3) Effect of this Embodiment

As described above, the storage apparatus 3 of the present embodiment periodically calculates the target core number that maximizes the reduction amount of power consumption while satisfying the performance required for the storage apparatus 3 itself with respect to the current load, compares the calculated target core number with the number of cores 20 in the operating state, stops the operation of the number of cores 20 that is the difference between both when the number of cores 20 in the operating state exceeds the target core number, and restarts the number of cores 20 in the stopped state that is the difference between both when the number of cores 20 in the operating state falls below the target core number.

Therefore, according to the present storage apparatus 3, since the number of cores 20 in the operating state is controlled to always coincide with the target core number, it is possible to reduce power consumption while always satisfying required performance and satisfying performance requirements.

### (2) Second Embodiment

FIG. 1 illustrates a storage system 50 according to a second embodiment as a whole. The storage system 50 is similar to the storage system 1 of the first embodiment in that a controller 52 of a storage apparatus 51 stops the core 20 of the CPU 12 or resumes the core 20 in the stopped state to the operating state according to the load.

However, the storage apparatus 51 of the present embodiment is different from the first embodiment in that the number of cores in the operating state can be changed depending on whether the performance of the storage apparatus 51 is emphasized or the reduction amount of the power consumption of the CPU 12 is emphasized, and is configured similarly to the storage system 1 of the first embodiment except for this.

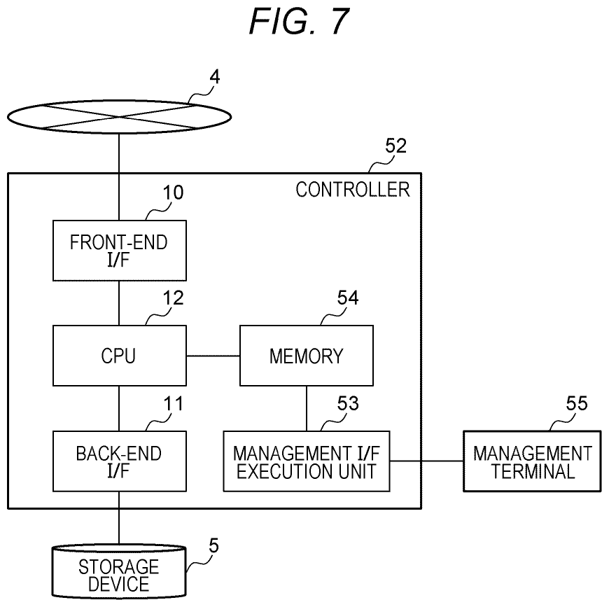

FIG. 7 in which the same reference numerals are assigned to corresponding parts with FIG. 2 illustrates a configuration example of the controller 52 of the storage apparatus 51 according to the second embodiment. In the present embodiment, a management interface execution unit 53 is provided in the controller 52, and the management interface execution unit 53 is connected to a memory 54. In addition, an external management terminal 55 is connected to the management interface execution unit 53.

The management terminal 55 is a computer apparatus used by an administrator to manage the storage apparatus 51. In addition, the management interface execution unit 53 is a functional unit having a function of causing the management terminal 55 to display a power consumption reduction policy selection screen to be described later.

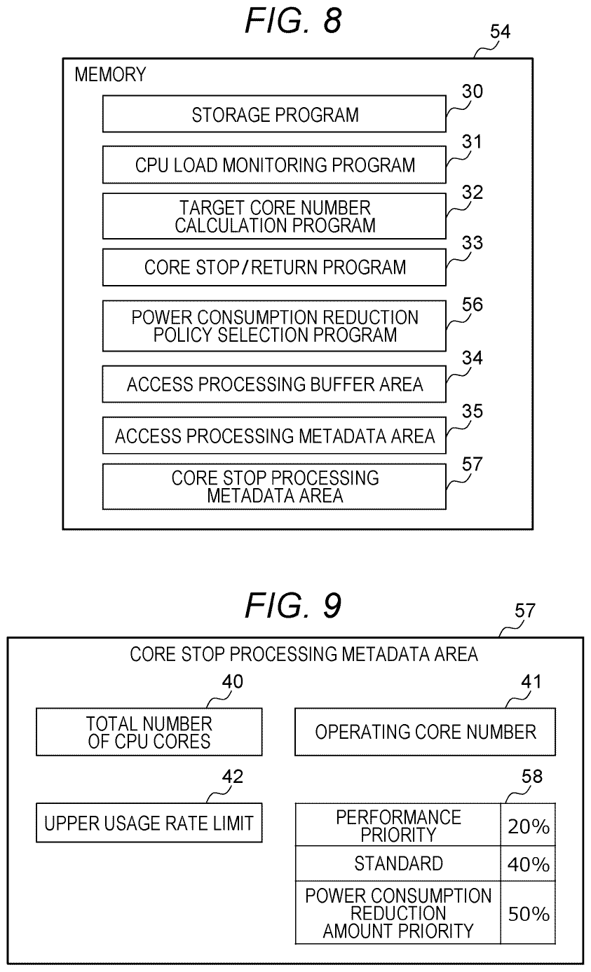

FIG. 8 in which the same reference numerals are assigned to corresponding parts with FIG. 4 illustrates a logical configuration of the memory 54 provided in the controller 52 of the storage apparatus 51 of the present embodiment. As illustrated in FIG. 8, the memory 54 of the storage apparatus 51 according to the present embodiment stores a power consumption reduction policy selection program 56 as a program in addition to the storage program 30, the CPU load monitoring program 31, the target core number calculation program 32, and the core stop/resume program 33 described above.

The power consumption reduction policy selection program 56 is a program having a function of causing the management terminal 55 to display a user interface screen (hereinafter, referred to as a power consumption reduction policy selection screen) for selecting which of the performance of the storage apparatus 51 and the reduction amount of the power consumption of the CPU 12 is emphasized as the power consumption reduction policy of the storage apparatus 51.

The management interface execution unit 53 causes the management terminal 55 to display the power consumption reduction policy selection screen based on the power consumption reduction policy selection program 56. In addition, the administrator uses the power consumption reduction policy selection screen displayed on the management terminal 55 to select which one of the performance of the storage apparatus 51 and the reduction amount of the power consumption of the CPU 12 is emphasized.

Here, in the case of the present embodiment, as the power consumption reduction policy, there are prepared three policies of “performance priority” in which the performance of the storage apparatus 51 is emphasized, “power consumption reduction amount priority” in which the reduction amount of the power consumption of the CPU 12 is emphasized, and “standard” in which the reduction amount of the power consumption of the CPU 12 is emphasized while the performance of the storage apparatus 51 is emphasized. Then, in the present embodiment, the upper usage rate limit of the CPU 12 is changed to a value corresponding to the power consumption reduction policy according to the selected power consumption reduction policy, thereby implementing the power consumption reduction policy.

Specifically, the upper usage rate limit of the CPU 12 is changed such that the upper usage rate limit of the CPU 12 becomes lower when “standard” is selected than when “power consumption reduction amount priority” is selected as the power consumption reduction policy, and the upper usage rate limit of the CPU 12 becomes lower when “performance priority” is selected than when “standard” is selected.

By doing so, as is apparent from Expression (1), the target core number calculated in step S3 of FIG. 6 can be made larger when “standard” is selected than when “power consumption reduction amount priority” is selected as the power consumption reduction policy, and when “performance priority” is selected than when “standard” is selected, and accordingly, more cores 20 can be operated to improve the performance of the storage apparatus 51.

Note that the power consumption reduction policy selection program 56 may be stored not in the memory 54 but in another memory connected to the management interface execution unit 53. In addition, a configuration in which the management interface execution unit 53 is not connected to the memory 54 but is connected to the CPU 12 may be applied. In this case, the management interface execution unit 53 accesses the memory 54 via the CPU 12 and reads the power consumption reduction policy selection program 56. Further, the management interface execution unit 53 may not be provided in the controller 52, and the core 20 of the CPU 12 may execute the power consumption reduction policy selection program 56 to cause the management terminal 55 to display the power consumption reduction policy selection screen.

Further, the power consumption reduction policy selection program 56 may be mounted on the management terminal 55, the management terminal 55 may be connected to the front-end network 4, and the power consumption reduction policy selected by the administrator using the power consumption reduction policy selection screen may be given from the management terminal 55 to the controller 52 of the storage apparatus 51 via the front-end network 4.

FIG. 9 in which the same reference numerals are assigned to the corresponding parts to FIG. 5 illustrates the configuration of a core stop processing metadata area 57 provided in the memory 54 of the controller 52 of the present embodiment. In the case of the present embodiment, a per-policy upper usage rate limit management table 58 is stored in the core stop processing metadata area 57 in addition to the total core number 40, the operating core number 41, and the upper usage rate limit 42 described above.

The per-policy upper usage rate limit management table 58 is a table that stores an optimum value of the upper usage rate limit for each policy of the priority regarding the performance of the storage apparatus 51 or the power consumption reduction amount of the CPU 12 in the calculation of the target core number. As described above, in the case of the present embodiment, three power consumption reduction policies of “performance priority”, “standard”, and “power consumption reduction amount priority” are prepared, and the optimum values of the upper usage rate limits for these power consumption reduction policies are stored in the per-policy upper usage rate limit management table 58. Note that the upper usage rate limit for each power consumption reduction policy is set lower as the power consumption reduction policy focuses on performance as described above.

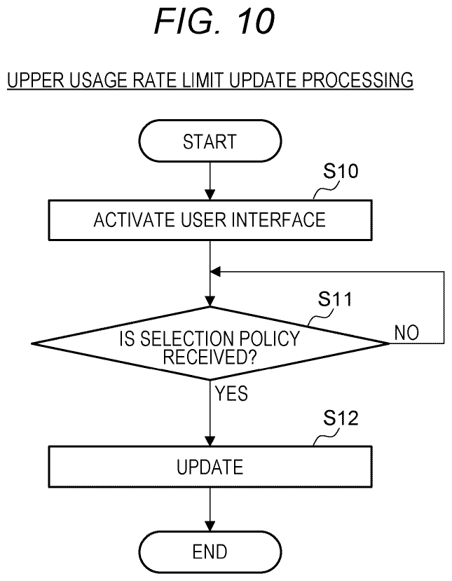

FIG. 10 illustrates a flow of a series of processes (hereinafter, referred to as upper usage rate limit update processing) executed in association with the update of the upper usage rate limit according to such a power consumption reduction policy. In the following description, the processing subject of various types of processing will be described as the power consumption reduction policy selection program 56, but in practice, it goes without saying that the management interface execution unit 53 executes the processing based on the power consumption reduction policy selection program 56.

When receiving the display request of the power consumption reduction policy selection screen transmitted from the management terminal 55 when the administrator performs a predetermined operation on the management terminal 55, the power consumption reduction policy selection program 56 starts the upper usage rate limit update processing. Then, the power consumption reduction policy selection program 56 first causes the management terminal 55 to display a power consumption reduction policy selection screen (S10).

Subsequently, the power consumption reduction policy selection program 56 waits for the power consumption reduction policy selected on the power consumption reduction policy selection screen by the administrator to be transmitted from the management terminal 55 (S11). Note that, in a case where the management terminal 55 is connected to the front-end network 4, the power consumption reduction policy selection program 56 may receive the power consumption reduction policy via the front-end network 4 or may receive the power consumption reduction policy from another program in the storage apparatus 51.

Then, when the power consumption reduction policy selected on the power consumption reduction policy selection screen by the administrator is transmitted from the management terminal 55 in due course, the power consumption reduction policy selection program 56 refers to the per-policy upper usage rate limit management table 58 stored in the core stop processing metadata area 57 (FIG. 9) of the memory 54. Then, the power consumption reduction policy selection program 56 reads the optimum value of the upper usage rate limit corresponding to the power consumption reduction policy selected by the administrator from the per-policy upper usage rate limit management table 58, and updates the value of the upper usage rate limit stored in the core stop processing metadata area 57 to the value read from the per-policy upper usage rate limit management table 58 at that time (S12). Thereafter, the power consumption reduction policy selection program 56 ends the upper usage rate limit update processing.

According to the storage apparatus 51 of the present embodiment having the above configuration, similarly to the storage apparatus 3 of the first embodiment, it is possible to perform control in consideration of the priority regarding the performance of the storage apparatus 51 and the reduction amount of the power consumption of the CPU 12 while satisfying the requirement regarding the performance and enabling the reduction of the power consumption.

### (3) Other Embodiments

Note that the first and second embodiments described above do not limit the scope of the claims in the present invention, and all the elements described in the embodiments are not necessarily required for solving the problems in the present invention. In addition, the configurations of the first and second embodiments can be freely changed without changing the gist of the invention.

For example, in the first and second embodiments described above, the case where only one CPU 12 is present in the controller 6 has been described, but the present invention is not limited thereto, and the present invention can also be applied to a case where a plurality of CPUs 12 are provided in the controller 6. In this case, the average usage rate of the CPU 12 may be acquired in the controller 6 in step S1 of FIG. 6, and the target core number in the entire controller 6 may be calculated in step S3.

Note that, in a case where there are a plurality of CPUs 12, when the surplus cores 20 are stopped in step S6, or when the cores 20 in the stopped state are resumed to the operating state in step S7, it is desirable to adjust the number of the cores 20 in the operating state to be equal in each CPU 12.

Therefore, when there are a plurality of CPUs 12, the number of cores 20 to be stopped or restarted in operation may be equally allocated to each CPU 12 based on the difference between the target core number calculated in step S4 and the operating core number 41 such that the number of cores 20 in the operating state is equal among the CPUs 12 in the controller 6, and each CPU 12 may be notified to stop or restart the operation of the cores 20 corresponding to the allocated number. Note that transmission of the number of cores 20 to be stopped or restarted between the CPUs 12 can be performed via the memory 13 or the like shared by the respective CPUs 12.

In the first and second embodiments described above, the case where the core stop/resume control processing described above with reference to FIG. 6 is periodically executed has been described, but the present invention is not limited thereto, and the core stop/resume control processing may be executed irregularly or in response to an execution instruction from an administrator. However, by periodically executing the core stop/resume control processing, there is an advantage that power consumption can be reduced while always satisfying required performance and satisfying performance requirements.

Furthermore, in the second embodiment described above, there are three power consumption reduction policies of “performance priority”, “standard”, and “power consumption reduction amount priority”, but the present invention is not limited thereto, and only two power consumption reduction policies (for example, “performance priority” and “power consumption reduction amount priority”) may be set, or four or more power consumption reduction policies may be set.

### INDUSTRIAL APPLICABILITY

The present invention can be applied to a storage apparatus.

What is claimed is:

1. A storage apparatus that provides a storage area for reading and writing data from and to a host apparatus, the storage apparatus comprising:
a storage device that provides the storage area for reading and writing data from and to the host apparatus; and
a controller that reads and writes data from and to the storage area of the storage device in response to a request from the host apparatus, wherein
the controller includes a processor,
the processor includes a plurality of cores that read and write data from and to the storage area of the storage device in response to a request from the host apparatus,
a maximum value of a usage rate of the processor capable of satisfying a performance requirement for the storage apparatus is defined as an upper usage rate limit, and
a number of cores in an operating state that maximizes an effect of reducing power consumption of the processor while satisfying the performance requirement is calculated as a target core number based on a ratio of an actual usage rate of the processor to the upper usage rate limit, and an operation of the core is stopped or the core in a stopped state is resumed to an operating state such that the calculated target core number is equal to the number of cores in the operating state.

2. The storage apparatus according to claim 1, wherein
the performance requirement is a requirement of a response time.

3. The storage apparatus according to claim 1, wherein
the target core number is periodically calculated, and the operation of the core is stopped or the core in the stopped state is resumed to the operating state such that the calculated target core number is equal to the number of cores in the operating state.

4. The storage apparatus according to claim 1, further comprising:
a core stop function unit that stops an operation of the core; and
a stopped core resume function unit that resumes the core in the stopped state to the operating state, wherein
one core constituting the processor calculates the target core number, and the core stop function unit or the stopped core resume function unit is controlled such that the calculated target core number is equal to the number of cores in the operating state.

5. The storage apparatus according to claim 1, wherein
an optimum value of the upper usage rate limit of the processor for each power consumption reduction policy is preset in association with each of a plurality of power consumption reduction policies, and
when one power consumption reduction policy is designated by an external operation, the upper usage rate limit of the processor is updated to the optimum value according to the designated power consumption reduction policy.

6. A control method of a storage apparatus that provides a storage area for reading and writing data from and to a host apparatus, wherein
the storage apparatus includes:
a storage device that provides the storage area for reading and writing data from and to the host apparatus; and
a controller that reads and writes data from and to the storage area of the storage device in response to a request from the host apparatus,
in the controller,
a processor is provided which includes a plurality of cores that read and write data from and to the storage area of the storage device in response to a request from the host apparatus,
a maximum value of a usage rate of the processor capable of satisfying a performance requirement for the storage apparatus is defined as an upper usage rate limit, and
the control method comprises:
a first step of calculating, by the storage apparatus, a number of cores in an operating state that maximizes an effect of reducing power consumption of the processor while satisfying the performance requirement as a target core number based on a ratio of an actual usage rate of the processor to the upper usage rate limit; and
a second step of stopping, by the storage apparatus, an operation of the core or resuming the core in a stopped state to an operating state such that the calculated target core number is equal to the number of cores in the operating state.

7. The control method of a storage apparatus according to claim 6, wherein
the performance requirement is a requirement of a response time.

8. The control method of a storage apparatus according to claim 6, further comprising a third step of periodically executing the first step and the second step by the storage apparatus.

9. The control method of a storage apparatus according to claim 6, wherein
the storage apparatus further includes:
a core stop function unit that stops an operation of the core; and
a stopped core resume function unit that resumes the core in the stopped state to the operating state, and
in the second step, any one of the cores controls the core stop function unit or the stopped core resume function unit such that, when one core constituting the processor calculates the target core number, the calculated target core number is equal to the number of cores in the operating state.

10. The control method of a storage apparatus according to claim 6, wherein
an optimum value of the upper usage rate limit of the processor for each power consumption reduction policy is preset in association with each of a plurality of power consumption reduction policies, and
in the third step, any one of the cores updates, when one power consumption reduction policy is designated by an external operation, the upper usage rate limit of the processor to the optimum value according to the designated power consumption reduction policy.
